(19) United States
(12) Patent Application Publication
(10) Pub. No.: US 2019/0163331 A1
(43) Pub. Date: May 30, 2019

(54) Multi-Modal Dialog Broker

(71) Applicant: International Business Machines Corporation, Armonk, NY (US)

(72) Inventors: Jonathan P. Epperlein, Phibsborough (IE); Yassine Lassoued, Dublin (IE); Jakub Marecek, Dublin (IE); Martin Mevissen, Dublin (IE); Julien Monteil, Dublin (IE); Giovanni Russo, Dublin (IE)

(21) Appl. No.: 15/823,754

(22) Filed: Nov. 28, 2017

(51) Int. Cl. G06F 3/0484

(52) U.S. Cl. CPC G06F 3/0484; H04L 67/42

(57) ABSTRACT

Embodiments describing an approach for managing multiple concurrent dialogs between a user and a plurality of devices and services based on a multi-modal dialog broker, embodiments comprise receiving instructions from at least one of: one or more users, the one or more devices, or the one or more services. Managing the instructions from the at least one of: one or more users, the one or more devices, or the one or more services. Obtaining one or more dialog variants. Determining a preferred dialog variant, in which responsive to determining the preferred dialog variant, executing the preferred dialog variant, and outputting the preferred dialog variant.

### BACKGROUND OF THE INVENTION

The present invention relates generally to the field of dialog systems, and more particularly to multi-modal dialog brokers.

Generic dialog systems (DS) facilitate the development of computer-human interfaces in a wide variety of applications. For an example of a generic dialog system, consider a cognitive cloud based service that allows users to: define dialog logic (workflows) and concepts related to dialogs, such as intents, entities, etc., train the system to recognise intents using example user inputs, and/or run a dialog through a set of stateless client-service interactions. In the context of multi-modal dialog applications, multiple and possibly concurrent dialogs need to be managed, which can lead to the following problems: dialogs having different intents, and hence different priorities and time constraints, dialogs trying to access one or more “modes” of interfacing with the user (screen, LED indicators, voice, etc.), possibly concurrently, either for an unknown period of time or with a considerable uncertainty as to the duration of the dialogs, which is related, in part, to the management of (possibly imperfectly recognised) user inputs and the subsequent requests to repeat or clarify. For example, how long would it take to (agree on an) answer? How much screen-space would it take (if not spoken)? This uncertainty makes the design of the DS tedious.

### SUMMARY

Embodiments of the present invention disclose a method, a computer program product, and a system for multi-modal dialog broker. A method for managing multiple concurrent dialogs between a user and a plurality of devices and services based on a multi-modal dialog broker, the method includes receiving, by the one or more processors, instructions from at least one of: one or more users, the one or more devices, or the one or more services. Managing, by the one or more processors, the instructions from the at least one of: one or more users, the one or more devices, or the one or more services. Obtaining, by the one or more processors, one or more dialog variants. Determining, by the one or more processors, a preferred dialog variant. Responsive to determining the preferred dialog variant, executing, by the one or more processors, the preferred dialog variant, and outputting, by the one or more processors, the preferred dialog variant.

A computer program product for managing multiple concurrent dialogs between a user and a plurality of devices and services based on a multi-modal dialog broker, the computer program product includes one or more computer readable storage devices and program instructions stored on the one or more computer readable storage devices, the stored program instructions comprising program instructions to receive instructions from at least one of: one or more users, the one or more devices, or the one or more services. Program instructions to manage the instructions from the at least one of: one or more users, the one or more devices, or the one or more services. Program instructions to obtain one or more dialog variants. Program instructions to determine a preferred dialog variant. Responsive to determining the preferred dialog variant, program instructions to execute the preferred dialog variant, and program instructions to output the preferred dialog variant.

A computer system for managing multiple concurrent dialogs between a user and a plurality of devices and services based on a multi-modal dialog broker, the computer system includes one or more computer processors, one or more computer readable storage devices, program instructions stored on the one or more computer readable storage devices for execution by at least one of the one or more computer processors, the stored program instructions comprising program instructions to receive instructions from at least one of: one or more users, the one or more devices, or the one or more services. Program instructions to manage the instructions from the at least one of: one or more users, the one or more devices, or the one or more services. Program instructions to obtain one or more dialog variants. Program instructions to determine a preferred dialog variant. Responsive to determining the preferred dialog variant, program instructions to execute the preferred dialog variant, and program instructions to output the preferred dialog variant.

### BRIEF DESCRIPTION OF THE DRAWINGS

FIG. 1 is a functional block diagram illustrating a distributed data processing environment, in accordance with an embodiment of the present invention;

FIG. 2 illustrates an example of uncertainty and/or criticality logic;

FIG. 3 is an example of dialog flow between a user and MMDBC 122;

FIG. 4 illustrates operational steps of a MMDBC 122, on a computing device within the distributed data processing environment of FIG. 1, in accordance with an embodiment of the present invention; and

FIG. 5 depicts a block diagram of components of the server computer executing the intelligent mapping program within the distributed data processing environment of FIG. 1, in accordance with an embodiment of the present invention.

### DETAILED DESCRIPTION

Embodiments of the present invention comprises an additional layer on top of the dialog system, called broker, that can manage multiple and possibly concurrent dialogs between a user and a multitude of devices or services, sharing one or more user interfaces (e.g., speakers and microphones enabling spoken dialog, touch screen enabling visual notifications and their touch-based confirmation, etc.), which improves the art of multi-modal dialog management. In embodiments of the present invention, the multi-modal dialog broker is responsible for the following: pass inputs/outputs between the dialog system and the appropriate user interfaces, control access to the user interfaces by concurrent dialogs (e.g., do not allow two dialogs to simultaneously access the microphone or speakers), depending on the criticality of the dialogs and the user preferences, control access to the devices (e.g., wait until a device is not busy or is ready to take a command), keep track of the user dialogs and interactions and their statuses, allow the user or a device to abort or interrupt a dialog, enable the user to request repeating the latest system request or response (e.g., when user did not hear the dialog system's output), ask the user to re-input a request or a response if the previous one was unclear (to the dialog system) or was invalid, enable a dialog to interrupt another dialog depending on customizable dialog priorities, and/or determine whether a dialog is complete, in which case the client is notified with the outcome of the dialog. It is these responsibilities that solve issues and uncertainties of generic dialog systems. Additionally, embodiments of the current invention can be used as an add-on for a cloud-based dialog system.

Embodiments of the present invention improve the art by including an additional layer to take care of the above tasks which will further facilitate dialog management and execution in applications, hence a proposed multi-modal dialog broker. Existing multi-modal interaction managers rely on a single, explicit specification of each dialog. Outside of application programming interface(s) (API's), there are many languages such as EMMA (Extensible Multi-Modal Annotation) markup language, VoiceXML, etc., which are used in the explicit specification. Embodiments of the present invention can provide multiple variants of each dialog, possibly making use of different interaction modalities, possibly dependent on the timings of user responses and/or similar responses. Additionally, a mixed-criticality multi-modal dialog broker can pick the appropriate dialog variants, based on: the rate of incoming requests for the rendering of dialogs, their priorities/criticalities and expected times (and other resources needed), constraints upon the execution of dialogs (e.g., expiration of an intent), uncertainty of dialog execution times, and/or availability of user interaction interfaces.

In embodiments of the present invention, the multi-modal dialog broker, can be an intermediary between the server (dialog system) and the clients (applications) and provides a layer that abstracts the interactions between: the dialog system, the user, and multiple applications/devices, through multiple interfaces (voice, touch screen, buttons, etc.). Embodiments of the present invention can be regarded as a framework that alleviates the effort of developing dialog management, interfacing, and execution functions on the client side, while handling the uncertainty in the requirements of time and screen-space. Embodiments of the present invention enable several advantages and improvements in the art, such as: an approach and architecture that extend the capabilities of dialog systems and managers to handle multiple concurrent dialogs, for interacting with multiple devices and services, sharing multiple user interfaces, a proposed broker sits on top of an existing dialog system and can be a manager that alleviates the effort of managing and controlling multiple dialogs with multiple user interfaces, configurable to run each dialog using an appropriate user interface, with a certain priority, and abstracts the way dialogs are managed by the dialog system/manager.

Embodiments of the present invention (e.g., a multi-modal dialog broker) describes a method for the management of the multiple and possibly concurrent dialogs between a user and a multitude of devices/services, through a set of shared user interfaces (e.g., speech, touch screen, etc.). It should be noted that although embodiments described herein focus on automobiles as an implementation environment, embodiments of the invention are not restricted to cars. The proposed system is multi-modal in the sense that it manages multiple devices, but also in that it manages multiple concurrent dialogs and multiple user interfaces (e.g., speech, touch screen, etc.). Embodiments of the present invention, can be used as an add-on to a cloud-based dialog system.

In various embodiments, Dialog (or Conversation) can be the specification of a workflow of interactions between a user and a machine, typically this can be represented as a flow chart.

In various embodiments, Dialog Instance can be an instance of a dialog workflow: a particular sequence of interactions between the machine and a user at a given time.

In various embodiments, Dialog System (DS) and/or Dialog Manager can be a computer system that is able to run and manage dialogs between a user and a machine (computer) and that can keep track of the dialog instance states.

In various embodiments, “Multi-modal” dialog manager can make use of multiple “modalities” (user interfaces) such as voice, beeps, (multiple) screens, diodes and related indicators, vibrations, etc.

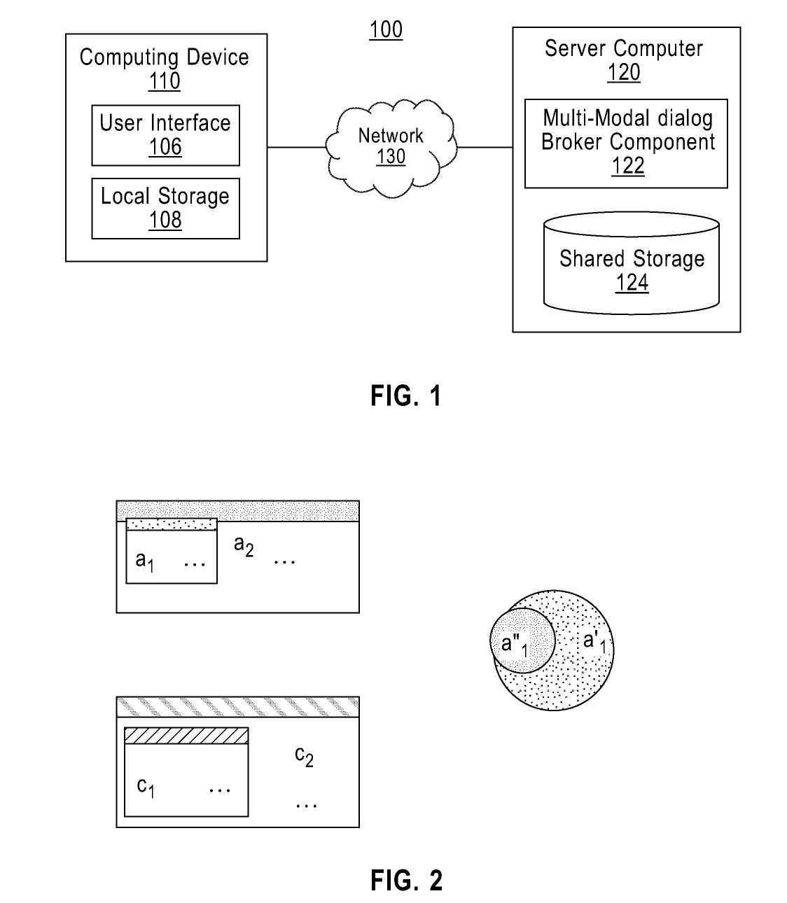

FIG. 1 is a functional block diagram illustrating a distributed data processing environment, generally designated 100, in accordance with one embodiment of the present invention. The term “distributed” as used in this specification describes a computer system that includes multiple, physically distinct devices that operate together as a single computer system. FIG. 1 provides only an illustration of one implementation and does not imply any limitations with regard to the environments in which different embodiments can be implemented. Many modifications to the depicted environment can be made by those skilled in the art without departing from the scope of the invention as recited by the claims.

Distributed data processing environment 100 includes computing device 110, server computer 120, interconnected over network 130. Network 130 can be, for example, a telecommunications network, a local area network (LAN), a wide area network (WAN), such as the Internet, a wireless technology for exchanging data over short distances (using short-wavelength ultra high frequency (UHF) radio waves in the industrial, scientific and medical (ISM) band from 2.4 to 2.485 GHz from fixed and mobile devices, and building personal area networks (PANs) or a combination of the three, and can include wired, wireless, or fiber optic connections. Network 130 can include one or more wired and/or wireless networks that are capable of receiving and transmitting data, voice, and/or video signals, including multimedia signals that include voice, data, text and/or video information. In general, network 130 can be any combination of connections and protocols that will support communications between computing device 110 and server computer 120, and other computing devices (not shown in FIG. 1) within distributed data processing environment 100.

In various embodiments, computing device 110 can be, but is not limited to, a standalone device, a server, a laptop computer, a tablet computer, a netbook computer, a personal computer (PC), a smart phone, a desktop computer, a smart television, a smart watch, a radio, stereo system, a cloud based service (e.g., a cognitive cloud based service), and/or any programmable electronic computing device capable of communicating with various components and devices within distributed data processing environment 100, via network 130 or any combination therein. In general, computing device 110 are representative of any programmable mobile device or a combination of programmable mobile devices capable of executing machine-readable program instructions and communicating with users of other mobile devices via network 130 and/or capable of executing machine-readable program instructions and communicating with server computer 120. In other embodiments, computing device 110 can represent any programmable electronic computing device or combination of programmable electronic computing devices capable of executing machine readable program instructions, manipulating executable machine readable instructions, and communicating with server computer 120 and other computing devices (not shown) within distributed data processing environment 100 via a network, such as network 130. Computing device 110 includes an instance of user interface 106. Computing device 110 and user interface 106 allow a user to interact with multi-modal dialog broker component 122 in various ways, such as sending program instructions, receiving messages, sending data, inputting data, editing data, correcting data and/or receiving data. In various embodiments, not depicted in FIG. 1, computing device 110 can have one or more user interfaces. In other embodiments, not depicted in FIG. 1 environment 100 can comprise one or more computing devices (e.g., at least two).

User interface (UI) 106 provides an interface to multi-modal dialog broker component 122 on server computer 120 for a user of computing device 110. In one embodiment, UI 106 can be a graphical user interface (GUI) or a web user interface (WUI) and can display text, documents, web browser windows, user options, application interfaces, and instructions for operation, and include the information (such as graphic, text, and sound) that a program presents to a user and the control sequences the user employs to control the program. In another embodiment, UI 106 can also be mobile application software that provides an interface between a user of computing device 110 and server computer 120. Mobile application software, or an “app,” is a computer program designed to run on smart phones, tablet computers and other mobile devices. In an embodiment, UI 106 enables the user of computing device 110 to send data, input data, edit data (annotations), correct data and/or receive data.

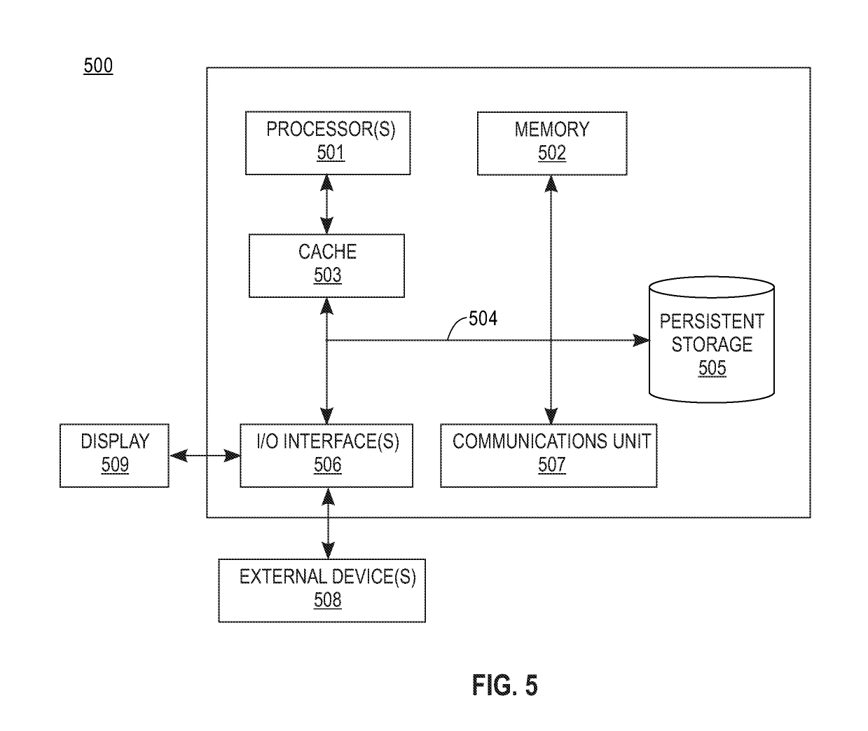

Server computer 120 can be a standalone computing device, a management server, a web server, a mobile computing device, or any other electronic device or computing system capable of receiving, sending, and processing data. In other embodiments, server computer 120 can represent a server computing system utilizing multiple computers as a server system, such as in a cloud computing environment. In another embodiment, server computer 120 can be a laptop computer, a tablet computer, a netbook computer, a personal computer (PC), a desktop computer, a personal digital assistant (PDA), a smart phone, or any other programmable electronic device capable of communicating with computing device 110 and other computing devices (not shown) within distributed data processing environment 100 via network 130. In another embodiment, server computer 120 represents a computing system utilizing clustered computers and components (e.g., database server computers, application server computers, etc.) that act as a single pool of seamless resources when accessed within distributed data processing environment 100. Server computer 120 can include multi-modal dialog broker component (MMDBC) 122 and shared storage 124. Server computer 120 can include internal and external hardware components, as depicted, and described in further detail with respect to FIG. 5.

Shared storage 124 and local storage 108 can be a data repository and/or a database that can be written to and/or read by one or a combination of MMDBC 122, server computer 120 and/or computing device 110. In the depicted embodiment, shared storage 124 resides on server computer 120. In another embodiment, shared storage 124 can reside elsewhere within distributed data processing environment 100 provided coverage assessment program 110 has access to shared storage 124. A database is an organized collection of data. Shared storage 124 and/or local storage 108 can be implemented with any type of storage device capable of storing data and configuration files that can be accessed and utilized by server computer 120, such as a database server, a hard disk drive, or a flash memory. In other embodiments, shared storage 124 and/or local storage 108 can be hard drives, memory cards, computer output to laser disc (cold storage), and/or any form of data storage known in the art. In various embodiments, MMDBC 122 can store and/or retrieve data from shared storage 124 and local storage 108. For example, MMDBC 122 will store user preferences and/or user dialog's to shared storage 124, in which MMDBC 122 can access at a later time to assist in future dialog interactions. In various embodiments, MMDBC 122 can have cognitive capabilities and learn from previous files and/or data MMDBC 122 has interacted with and/or has stored to local storage 108 and/or shared storage 124. For example, retrieving and analyzing previously generated dialog variants, analyzed user response and/or user priority preferences, etc.

In various embodiments, MMDBC 122 can sit between the server (dialog system) and the clients (applications) and provides a layer that abstracts the interactions between: the dialog system, the user, and multiple applications/devices (e.g., plurality of applications and/or devices), through multiple interfaces (voice, touch screen, buttons, etc.). In various embodiments, MMDBC 122 can connect to one or more computing devices (e.g., plurality of computing devices), receive, analyze, prioritize, and/or manage multiple devices and/or dialog concurrently. For example, connecting to a smartphone, navigation system, and stereo system, in which a user can control music streaming from the smartphone, the navigation system, and the stereo system via voice command, via MMDBC 122, while MMDBC 122 simultaneously manages any incoming calls, texts, music streaming from the smartphone, news alerts, traffic alerts, navigation, stereo volume, vehicle maintenance alerts (e.g., low tire pressure), and/or weather alerts.

In various embodiments MMDBC 122 can comprise a dialog system and uncertain durations of their parts related to intents a1∈R×R (e.g., time, screen-space), a2∈R (e.g., time), in which MMDBC 122 can the dialog system and uncertainty durations use to determine mixed criticality. For example, if the realization of parameter a1 is within a circle a″1, consider also an additional part a2 (and the related variables and constraints), or if the observed realization of parameter a1 is outside the circle a″1, do not consider part a2 (and the related variables and constraints), and given specification of such parts across all dialogs, pick the most important parts across all dialogs, as depicted in FIG. 2. The additional part a2 can comprise additional information, explanations for questions, additional questions, and confirmations.

In more detail MMDBC 122 can suggest a destination, ask details about the route, receive user feedback, and confirm the destination. For example:

MMDBC 122: “are you going to work?”

User: “No”

MMDBC: “Where are you going then?”

User: “To the football match downtown”

MMDBC: “Okay. Would you like me navigate?”

User: “Yes and find the fastest route.”

MMDBC: “You got it. Displaying the fastest route to the football match.”

In various embodiments, in relation to the treatment of uncertainty, MMDBC 122 can have two variants of a dialog with the same context (e.g., captured by the duration and screen-space requirements of a shared part of the dialog, starting with “Are you going to work?”). In this particular embodiment, the context (e.g., the duration of the shared data) is captured by a multi-variant random variable called a1, whose realization is unknown, and in this particular embodiment there can be 2 dimensional measurements, with units being seconds and square inches. In this particular embodiment, if a1 is within the area a1′, but not within a1″ (e.g., because the user had to repeat the response in the shared part), we can continue only with a restricted continuation (c1), as shown in FIG. 2. This has higher “criticality.” In various embodiments, if a1 is within the area a1″, MMDBC 122 can continue with a more informative continuation (c2). This has lower “criticality.” In various embodiments, given such “mixed-criticality” specification/selection of the multiple options across all dialogs, selected variants of the dialogs such that one (high-criticality) dialog over-runs other dialogs, MMDBC 122 can use a high-criticality variant instead of a low-criticality variant to make up for the uncertainty. In some embodiments, MMDBC 122 can use a standard language, such as the W3C recommended EMMA 2.0, for defining the dialog variants.

In various embodiments, MMDBC 122 presents 3 variants of a dialog to alert the driver about a Light Detecting and Ranging (LiDAR) failure. In various embodiments, each variant adds more information compared to the shorter version variant. In this particular embodiment, MMDBC 122 picks up the most suitable dialog variant depending on the criticality and priority of the LiDAR alert, and on the availability of user interaction interfaces. For example, dialog variant 1 (short): express LiDAR failure on screen and/or by speech; dialog variant 2 (medium): express LiDAR failure and suggest LiDAR occlusion on screen and/or by speech; and/or dialog variant 3 (long): express LiDAR failure, suggest LiDAR occlusion, and explain the difficulties interpreting LiDAR data using both screen and speech if possible. A dialog variant can be, but is not limited to, one variant of the dialog workflow and the associated devices needed to execute it and/or the associated user priority preferences, and/or dialog avenues to pursue, possibly with information about the duration of the execution and/or information about the uncertainty in the duration of the execution.

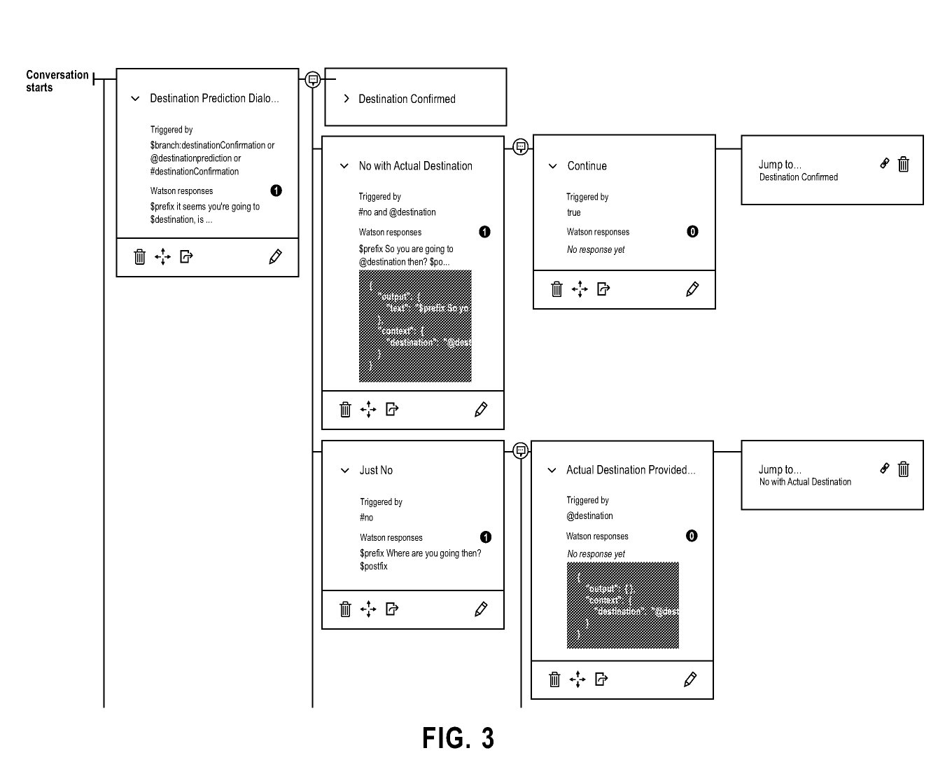

In another example, Dialog variant 1 (short): Tell Driver: “If you are going to the office then I suggest you take the next exit and drive through Lucan”; dialog variant 2 (medium): Ask user: “It seems you are going to the office, is that correct?” If driver says “no” then abort, if the driver says “yes” then tell the user: “Then I recommend that you take the next exit from M50 and continue on N4 through Lucan” and display “accident on M50” message on screen; and/or dialog variant 3 (long): Ask user: “It seems you are going to the office, is that correct?” If driver says “no” then abort, if the driver says “yes” then tell the user: “Then I recommend that you take the next exit from M50 and continue on N4 through Lucan” and display” accident on M50″ message on screen, and If driver asks “why” then explain: “There is an accident ahead on M50 with expected delays of more than 40 minutes,” if the diver asks “can you suggest another alternative?” then say “no”. Ask driver “Do you need any further assistance from me while driving on N4?”, etc. Another dialog and/or dialog variant example can be seen in FIG. 3. FIG. 3 illustrates one embodiment of conversation flow and thought process between the user and MMDBC 122 utilizing a cognitive cloud based service.

In various embodiments, MMDBC 122 can evaluate mixed criticality automatically based on learned user habits and/or based on user input preferences (e.g., user defined priorities). For example, user defined priorities can be defined as follows: phone calls have the highest priority; suspend any other speech dialog if there is an incoming call. During a call, while the speech interface is busy, redirect the navigation system outputs to the display panel. In various embodiments, MMDBC 122 use mixed criticality as a scheduler (e.g., mixed criticality scheduler) to schedule, manage, and/or optimize the execution of one or more dialogs and/or services through a set of shared user interfaces; as opposed to predefined workflow as per traditional dialog systems. In various embodiments, MMDBC 122 can analyze and interpret constraints. For Example, MMDBC 122 is engaging with the driver in a dialog, the purpose of which is to recommend that the driver should turn right in 500 meters. At the same time, a text message is received and needs to be read/displayed to the driver. Given the urgency of turning right, the dialog broker decides to display the text message on the screen interface, and continue with the navigation dialog.

In a more detailed example: The MMDBC 122 receives a message from the navigation system to instruct the driver to “Turn right in 500 feet”, and pauses music being streamed to the vehicle's stereo system from a user smartphone, via network 130. At the same time a text message from the driver's spouse is received. Reading the message to the driver will delay the instruction to turn right, which can cause the driver to miss the right-turn. The display cannot be available or the display can increase the cognitive load on the driver too much. Therefore, the MMDBC decides to hold. MMDBC 122 instructs the driver to turn right. When some time has lapsed (meaning the driver did not require an explanation or object) MMDBC reads the text message to the driver.

In various embodiments, MMDBC 122 can evaluate and/or determine risks. For example, MMDBC 122 learns of an accident ahead. It recommends that the driver turns right at the next opportunity. In this particular example, if the driver follows instructions, the turn can be this intersection, but if he interrogates/questions MMDBC 122 for any reason, MMDBC 122 can instruct the user to turn at the next intersection. Additionally, in this particular example, If MMDBC 122 needs an input, it can take 3 seconds if it is understood, and/or more than 3 seconds (e.g., 5 or more seconds) if MMDBC 122 needs to announce that it has failed to recognize the utterance and prompts the user to pronounced it again. In some embodiments, it can take even longer, if multiple repetitions/pronunciations are required.

In various embodiments, MMDBC 122 can connect and/or manage multiple devices and/or multiple services. For example, consider a vehicles device such as a mobile phone, sensors comprising of cameras and lidars, radio, CD player, lights, wipers, windows, air conditioning unit, and/or a vehicle service such as driving assistants and self-driving systems, navigation, weather, cruise control, speed advice, traffic info, etc. In various embodiments, a user can interact with devices and services through a set of user interfaces to execute various commands and/or receive information such as: speech user interface through a mobile phone's microphone or car's microphone array (for user inputs), speakers (for device and service outputs), touch screen, push button monitor, and/or any other user interface known in the art. In various embodiments, a remote dialog system (DS), such as a cognitive cloud based system, including a dialog manager, manages the dialogs required by the devices (e.g., dialog workflow, intents, entities, etc.). In various embodiments, a dialog in the DS is typically focused on a task, associated with a given device or service (e.g., get optimal route to one or more destinations, risk mitigation, etc.). A dialog (e.g., workflow) can require one or more interactions. In this particular embodiment, multiple devices can need to access the DS and interact with the user through the variety of user interfaces, possibly at the same time (concurrently), and MMDBC 122 can receive, analyze, prioritize, and/or manage multiple devices and/or dialogs concurrently. In various embodiments, MMDBC 122 can interact with a user and/or computing device using a simple dialog (e.g., User: “switch off the radio”) and/or a more complex dialog (e.g., MMDBC 122: “it seems you are going to the office”, User: “No”, MMDBC 122: “Where are you going?” User: “To the Supermarket”, MMDBC 122: “Sorry, I did not understand what you said”, etc.). In another embodiment, the dialog can be between the user, a risk assessment service, a navigation system, a cloud based operating system, and/or any system known in the art, wherein MMDBC 122 can broker the dialog between the user and the one of more systems.

In various embodiments, MMDBC 122 can learn a user's preferences and/or user priority preferences. For example, Phone messages have the highest priority and suspend any other speech dialog if a message is received. A traffic alert can have a lower priority: if it is received while speech interface is busy, then the traffic alert is redirected to the touch screen. In various embodiments, MMDBC 122 can learn a user's priority preferences by interacting with a user and storing dialog exchanges on local storage 108 and/or shared storage 124. For example, a driver usually instructs MMDBC 122 to hold text messages until after completing navigation instructions/dialogs. In some embodiments, MMDBC 122 can enable a user to manually select and/or enter preferences and/or priority preferences. User priority preferences can be time delay between notifications, uncertainty duration, music preferences, volume preferences, notification priority, air condition preferences, preferred dialog variants, and/or any other preferences known in the art.

In some embodiments, the uncertainty in the duration of the execution of a particular dialog variant can depend on one or more computing devices used in the execution, time of day, cognitive load and other user physiological data. Cognitive load and/or a user's cognitive load can be the user's mental capability and/or mental capacity. In some embodiments, a user's cognitive load can be impaired by drugs, alcohol, illness, disease, injury, and/or lack of sleep. In many applications, one example can be considered a conditional distribution. For example, the rate at which the system fails to recognize what the user is saying depends on the quality of the microphones. In turn, this affects the duration, by requiring the system to ask the user to repeat. For example, the rate at which the system fails to recognize what the user is saying depends on the cognitive load of the driver. If the driver reads a text message, changes gears ahead of a turn, and listens to his favorite podcast, the podcast and the speech of the user can get confused and there can be gaps in the user's utterances, requiring multiple repetitions. For example, the rate at which the system fails to recognize what the user is saying depends on other physiological features of the driver. If the driver is under the influence of alcohol, a slurred speech can be particularly hard to understand and can require multiple repetitions. In some embodiments, such conditioning of the execution of duration of data can be employed for the performance of the system.

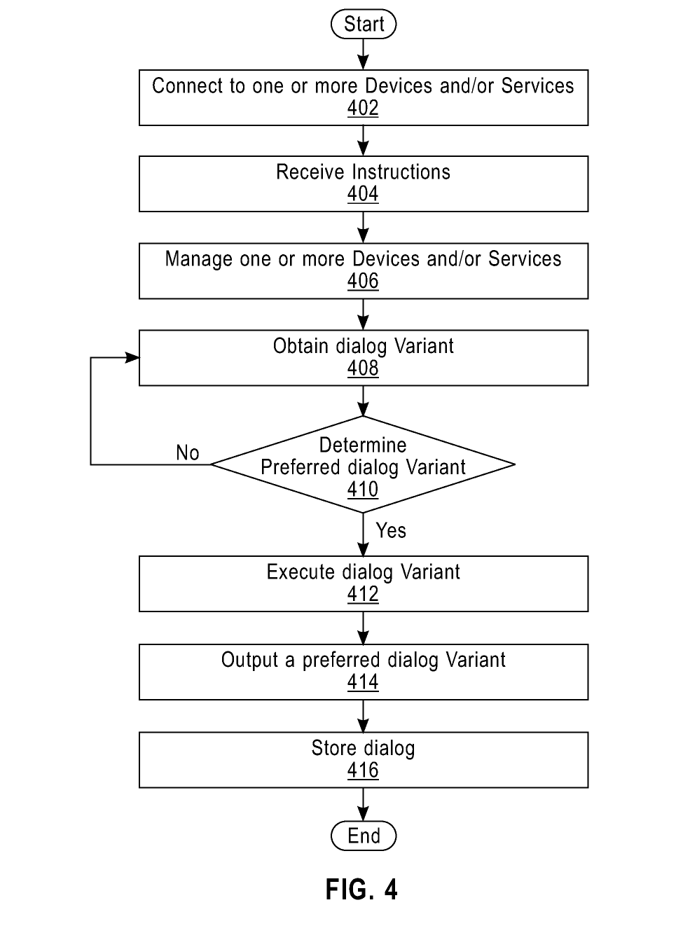

FIG. 4 is a flowchart depicting operational steps of MMDBC 122, on server computer 120 within distributed data processing environment 100 of FIG. 1, in accordance with an embodiment of the present invention. It should be appreciated that FIG. 4 provides only an illustration of one implementation and does not imply any limitations with regard to the environments in which different embodiments can be implemented. Many modifications to the depicted environment can be made.

In step 402, MMDBC 122 connects to one or more devices and/or services. In various embodiment, MMDBC 122 can connect to one or more devices (e.g., computing devices), and/or one or more services (e.g., music streaming, navigation, stereo system, etc.). In various embodiments, MMDBC 122 can manage and communicate to the one or more connected computing devices and/or one or more services concurrently.

In step 404, MMDBC 122 receives instructions. In various embodiments, MMDBC 122 can receive instructions from one or more user's and/or one or more computing devices via voice command, touch screen, push button, and/or any user interface known in the art. In various embodiments, MMDBC 122 can receive instructions to manage one or more computing devices.

In step 406, MMDBC 122 manages one or more devices and/or services. In various embodiments, MMDBC 122 can manage one or more devices and/or services and integrate them onto one or more user interfaces. In various embodiments, MMDBC 122 can manage information/instructions received from one or more devices and/or one or more services based on a user's priority preferences and/or mixed criticality.

In step 408, MMDBC 122 obtains one or more dialog variants. In some embodiments, obtain can comprise at least one of receiving and/or generating one or more dialog variants. In some embodiments, MMDBC 122 can receive one or more dialog variants. In some embodiments, MMDBC 122 can generate one or more predicted dialog variances. In some embodiments, MMDBC 122 can receive and/or generate information about priority and/or information about uncertainty in the duration of the dialog variants. In some embodiments, these can take the form suggested by the mixed criticality framework, where the duration is seen as a random variable and multiple sub-intervals of its support are associated with differing priorities. Additionally, in some embodiments, MMDBC 122 can use frequentist machine learning to learn the information about the duration of the dialog variants and feedback alongside a model of response to the feedback such as multi-armed bandits to learn the preferences.

In step 410, MMDBC 122 determines the preferred dialog variant. In various embodiments, MMDBC 122 can determine a user's preferred dialog, via receiving user feedback/response(s). In various embodiments, if MMDBC 122 determines a user's preferred dialog variant (Yes branch) then MMDBC 122 can advance to step 412. In various embodiments, if MMDBC 122 cannot determine a user's preferred dialog variant (No branch) than MMDBC 122 can generate new dialog variants and/or repeat previously generated dialog variants (e.g., repeat steps 408-410) until MMDBC 122 determines a user's preferred dialog variant. In various embodiments, MMDBC 122 can use mixed criticality to determine the preferred dialog variant. Additionally, in some embodiments, MMDBC 122 can use learned priority preferences to determine dialog variants. In various embodiments, in step 208, MMDBC 122 can determine priority of the dialog variant by engaging in dialog with the user and/or analyzing feedback on past user dialogs and/or priority preferences for other similar dialog variants. In various embodiments, MMDBC 122 can determine the user's preferred dialog variant by engaging the user in dialog (e.g., prompting question to the user and receiving user feedback/response(s)). In some embodiments, MMDBC 122 can learn a model of the uncertainty of the duration of one or more dialog variants, wherein the learned model is based on one or more computing devices being used in the execution of the preferred dialog variant.

In step 412, MMDBC 122 executes the dialog variant. In various embodiments, MMDBC 122 is responsive to the determined preferred dialog variant. In various embodiments, MMDBC 122 can execute one or more dialog variants and/or one or more preferred dialog variants. In various embodiments, MMDBC 122 can execute the dialog between a user and one or more computing devices and/or cognitive cloud based service. In various embodiments, MMDBC 122 can record uncertainty in the duration of execution, wherein the uncertainty in the duration of the execution of the preferred dialog variant is based on at least one of: the execution of the preferred variant (e.g., preferred dialog variant), time of day, or the user's cognitive load. In some embodiments recording uncertainty in the duration of execution comprises at least one of: studying, analyzing, and/or cognitively learning the uncertainty in the duration of execution.

In step 414, MMDBC 122 outputs a preferred dialog variant. In various embodiments, MMDBC 122 can output one or more preferred dialog variants. In various embodiments, MMDBC 122 can output one or more preferred dialog variants to one or more computing devices. In various embodiments, MMDBC 122 can output the preferred dialog variant based on priority preferences. In various embodiments, MMDBC 122 can output one or more preferred dialog variants to a user, via one or more user interfaces.

In step 416, MMDBC 122 stores dialog between the user and one or more computing devices. In various embodiments, MMDBC 122 can store the dialog between a user and one or more computing devices and/or cognitive cloud based service. In various embodiments, MMDBC 122 can store the dialog between a user and one or more computing devices and/or cognitive cloud based service and/or the outputted one or more preferred dialog variants on local storage 108 and shared storage 124.

FIG. 5 depicts a block diagram of components of server computer 120 within distributed data processing environment 100 of FIG. 1, in accordance with an embodiment of the present invention. It should be appreciated that FIG. 5 provides only an illustration of one implementation and does not imply any limitations with regard to the environments in which different embodiments can be implemented. Many modifications to the depicted environment can be made.

FIG. 5 depicts computer system 500, where server computer 120 represents an example of computer system 500 that includes MMDBC 122. The computer system includes processors 501, cache 503, memory 502, persistent storage 505, communications unit 507, input/output (I/O) interface(s) 506 and communications fabric 504. Communications fabric 504 provides communications between cache 503, memory 502, persistent storage 505, communications unit 507, and input/output (I/O) interface(s) 506. Communications fabric 504 can be implemented with any architecture designed for passing data and/or control information between processors (such as microprocessors, communications, and network processors, etc.), system memory, peripheral devices, and any other hardware components within a system. For example, communications fabric 504 can be implemented with one or more buses or a crossbar switch.

Memory 502 and persistent storage 505 are computer readable storage media. In this embodiment, memory 502 includes random access memory (RAM). In general, memory 502 can include any suitable volatile or non-volatile computer readable storage media. Cache 503 is a fast memory that enhances the performance of processors 501 by holding recently accessed data, and data near recently accessed data, from memory 502.

Program instructions and data used to practice embodiments of the present invention can be stored in persistent storage 505 and in memory 502 for execution by one or more of the respective processors 501 via cache 503. In an embodiment, persistent storage 505 includes a magnetic hard disk drive. Alternatively, or in addition to a magnetic hard disk drive, persistent storage 505 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 505 can also be removable. For example, a removable hard drive can be used for persistent storage 505. Other examples include optical and magnetic disks, thumb drives, and smart cards that are inserted into a drive for transfer onto another computer readable storage medium that is also part of persistent storage 505.

Communications unit 507, in these examples, provides for communications with other data processing systems or devices. In these examples, communications unit 507 includes one or more network interface cards. Communications unit 507 can provide communications through the use of either or both physical and wireless communications links. Program instructions and data used to practice embodiments of the present invention can be downloaded to persistent storage 505 through communications unit 507.

I/O interface(s) 506 enables for input and output of data with other devices that can be connected to each computer system. For example, I/O interface 506 can provide a connection to external devices 508 such as a keyboard, keypad, a touch screen, and/or some other suitable input device. External devices 508 can also include portable computer readable storage media such as, for example, thumb drives, portable optical or magnetic disks, and memory cards. Software and data used to practice embodiments of the present invention can be stored on such portable computer readable storage media and can be loaded onto persistent storage 505 via I/O interface(s) 506. I/O interface(s) 506 also connect to display 509.

Display 509 provides a mechanism to display data to a user and can be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention can be a system, a method, and/or a computer program product. The computer program product can include a computer readable storage medium (or media) having computer readable program instructions thereon for causing a processor to carry out aspects of the present invention.

The computer readable storage medium can be any tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention can be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions can be provided to a processor of a general-purpose computer, a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions can also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams can represent a module, a segment, or a portion of instructions, which comprises one or more executable instructions for implementing the specified logical function(s). In some alternative implementations, the functions noted in the blocks can occur out of the order noted in the Figures. For example, two blocks shown in succession may, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method for managing multiple concurrent dialogs between a user and a plurality of devices and services based on a multi-modal dialog broker, the method comprising:
receiving, by one or more processors, instructions from at least one of: one or more users, the one or more devices, or the one or more services;
managing, by the one or more processors, the instructions from the at least one of: one or more users, the one or more devices, or the one or more services;
obtaining, by the one or more processors, one or more dialog variants;
determining, by the one or more processors, a preferred dialog variant;
responsive to determining the preferred dialog variant, executing, by the one or more processors, the preferred dialog variant; and
outputting, by the one or more processors, the preferred dialog variant.

2. The method of claim 1, wherein obtaining one or more dialog variants further comprises at least one of receiving or generating the one or more dialog variants, wherein the receiving or generating the one or more dialog variants further comprises at least one of generating or receiving the one or more user's priority preferences or a description of uncertainty in the duration of the one or more dialog variants for one of more dialog variants.

3. The method of claim 1, wherein determining the preferred dialog variant further comprises at least one of: optimizing a choice of the one or more dialog variants jointly across multiple dialogs or services based on a mixed criticality scheduler and restrictions of a set of shared user interfaces, or one or more user's preferences and uncertainty in the duration of the one or more dialog variants.

4. The method of claim 1, wherein executing the preferred dialog variant further comprises recording uncertainty in the duration of execution, wherein the uncertainty in the duration of the execution of the preferred dialog variant is based on at least one of: the execution of the preferred dialog variant, time of day, or the user's cognitive load.

5. The method of claim 1, wherein determining the preferred dialog variant comprises further comprises:
learning, by the one or more processors, one or more user priority preferences.

6. The method of claim 1, wherein determining the preferred dialog variant further comprises:
learning, by the one or more processors, a model of uncertainty of the duration of the one or more dialog variant.

7. The method of claim 6, wherein learning a model of the uncertainty is based on one or more computing devices being used in the execution of the preferred dialog variant.

8. A computer program product for managing multiple concurrent dialogs between a user and a plurality of devices and services based on a multi-modal dialog broker, the computer program product comprising:
one or more computer readable storage devices and program instructions stored on the one or more computer readable storage devices, the stored program instructions comprising:
program instructions to receive instructions from at least one of: one or more users, the one or more devices, or the one or more services;
program instructions to manage the instructions from the at least one of: one or more users, the one or more devices, or the one or more services;
program instructions to obtain one or more dialog variants;
program instructions to determine a preferred dialog variant;
responsive to determining the preferred dialog variant, program instructions to execute the preferred dialog variant; and
program instructions to output the preferred dialog variant.

9. The computer program product of claim 8, wherein program instructions to obtain one or more dialog variants further comprises at least one of: receiving or generating the one or more dialog variants, wherein the receiving or generating the one or more dialog variants further comprises at least one of generating or receiving the one or more user's priority preferences or a description of uncertainty in the duration of the one or more dialog variants for one of more dialog variants.

10. The computer program product of claim 8, wherein program instructions to determine the preferred dialog variant further comprises at least one of: optimizing a choice of the one or more dialog variants jointly across multiple dialogs or services based on a mixed criticality scheduler and restrictions of a set of shared user interfaces, or one or more user's preferences and uncertainty in the duration of the one or more dialog variants.

11. The computer program product of claim 8, wherein program instructions to execute the preferred dialog variant further comprises recording uncertainty in the duration of execution, wherein the uncertainty in the duration of the execution of the preferred dialog variant is based on at least one of: the execution of the preferred dialog variant, time of day, or the user's cognitive load.

12. The computer program product of claim 8, wherein program instructions to determine the preferred dialog variant comprises further comprises:
program instructions to learn one or more user priority preferences.

13. The computer program product of claim 8, wherein program instructions to determine the preferred dialog variant further comprises:
program instructions to learn a model of uncertainty of the duration of the one or more dialog variant.

14. The computer program product of claim 13, wherein program instructions to learn a model of uncertainty is based on one or more computing devices being used in the execution of the preferred dialog variant.

15. A computer system for managing multiple concurrent dialogs between a user and a plurality of devices and services based on a multi-modal dialog broker, the computer system comprising:
one or more computer processors;
one or more computer readable storage devices;
program instructions stored on the one or more computer readable storage devices for execution by at least one of the one or more computer processors, the stored program instructions comprising:
program instructions to receive instructions from at least one of: one or more users, the one or more devices, or the one or more services;
program instructions to manage the instructions from the at least one of: one or more users, the one or more devices, or the one or more services;
program instructions to obtain one or more dialog variants;
program instructions to determine a preferred dialog variant;
responsive to determining the preferred dialog variant, program instructions to execute the preferred dialog variant; and
program instructions to output the preferred dialog variant.

16. The system of claim 15, wherein program instructions to obtain one or more dialog variants further comprises at least one of: receiving or generating the one or more dialog variants, wherein the receiving or generating the one or more dialog variants further comprises at least one of generating or receiving the one or more user's priority preferences or a description of uncertainty in the duration of the one or more dialog variants for one of more dialog variants.

17. The system of claim 15, wherein program instructions to determine the preferred dialog variant further comprises at least one of: optimizing a choice of the one or more dialog variants jointly across multiple dialogs or services based on a mixed criticality scheduler and restrictions of a set of shared user interfaces, or one or more user's preferences and uncertainty in the duration of the one or more dialog variants.

18. The system of claim 15, wherein program instructions to execute the preferred dialog variant further comprises recording uncertainty in the duration of execution, wherein the uncertainty in the duration of the execution of the preferred dialog variant is based on at least one of: the execution of the preferred dialog variant, time the day, or the user's cognitive load.

19. The system of claim 15, wherein program instructions to determine the preferred dialog variant comprises further comprises:
program instructions to learn one or more user priority preferences.

20. The system of claim 15, wherein program instructions to determine the preferred dialog variant further comprises:
program instructions to learn a model of uncertainty of the duration of the one or more dialog variant, wherein program instructions to learn a model of uncertainty is based on one or more computing devices being used in the execution of the preferred dialog variant.
